(19) United States
(12) Patent Application Publication
(10) Pub. No.: US 2012/0142520 A1
(43) Pub. Date: Jun. 7, 2012

(54) CONTROLLED ACTIVITY PYROLYSIS CATALYSTS

(75) Inventors: Robert Bartek, Centennial, CO (US); Michael Brady, Studio City, CA (US); Dennis Stamires, Dana Point, CA (US)

(73) Assignee: KIOR INC., PASADENA, TX (US)

(21) Appl. No.: 13/262,910

(22) PCT Filed: Apr. 22, 2010
(86) PCT No.: PCT/US10/32026

§ 371 Date: Feb. 23, 2012

Related U.S. Application Data
(60) Provisional application No. 61/171,509, filed on Apr. 22, 2009.

(51) Int. Cl. B01J 35/10; B01J 21/10; B01J 23/745; B01J 23/34; B01J 23/72; B01J 23/06; B01J 23/10; B01J 21/06; B01J 21/16; B01J 27/236; B01J 29/08; B01J 29/40; B01J 21/04; B01J 21/08; B01J 23/02

(52) U.S. Cl. 502/71; 502/300; 502/340; 502/338; 502/324; 502/345; 502/343; 502/304; 502/303; 502/240; 502/80; 502/176; 502/79; 502/77; 502/355; 502/341; 502/336; 502/346; 502/250; 502/251; 502/258; 502/241; 502/244; 502/253; 502/263; 502/64; 502/63

(57) ABSTRACT

A catalyst system is disclosed for catalytic pyrolysis of a solid biomass material. The system comprises an oxide, silicate or carbonate of a metal or a metalloid. The specific combined meso and macro surface area of the system is in the range of from 1 m²/g to 100 m²/g. When used in a catalytic process the system provides a high oil yield and a low coke yield. The liquid has a relatively low oxygen content.

### BACKGROUND OF THE INVENTION

1. Field of the Invention

The invention relates generally to catalysts for use in a catalytic pyrolysis process, and more particularly to catalysts for use in a catalytic pyrolysis process for converting solid biomass material.

2. Description of the Related Art

There is an urgent need to find processes for converting solid biomass materials to liquid fuels as a way to reduce mankind's dependence on crude oil, to increase the use of renewable energy sources, and to reduce the build-up of carbon dioxide in the earth's atmosphere.

Pyrolysis processes, in particular flash pyrolysis processes, are generally recognized as offering the most promising routes to the conversion of solid biomass materials to liquid products, generally referred to as bio-oil or bio-crude. In addition to liquid reaction products, these processes produce gaseous reaction products and solid reaction products. Gaseous reaction products comprise carbon dioxide, carbon monoxide, and relatively minor amounts of hydrogen, methane, and ethylene.

The solid reaction products comprise coke and char.

In order to maximize the liquid yield, while minimizing the solid and gaseous reaction products, the pyrolysis process should provide a fast heating rate of the biomass feedstock, a short residence time in the reactor, and rapid cooling of the reaction products. Lately the focus has been on ablative reactors, cyclone reactors, and fluidized reactors to provide the fast heating rates. Fluidized reactors include both fluidized stationary bed reactors and transport reactors.

Transport reactors provide heat to the reactor feed by injecting hot particulate heat carrier material into the reaction zone. This technique provides rapid heating of the feedstock. The fluidization of the feedstock ensures an even heat distribution within the mixing zone of the reactor.

U.S. Pat. No. 5,961,786 discloses a process for converting wood particles to a liquid smoke flavoring product. The process uses a transport reactor, with the heat being supplied by hot heat transfer particles. The document mentions sand, sand/catalyst mixtures, and silica-alumina catalysts as potential heat transfer materials. All examples are based on sand as the heat carrier, with comparative examples using char. The document reports relatively high liquid yields in the range of 50 to 65%. The liquid reaction products had a low pH (around 3) and high oxygen content. The liquid reaction products would require extensive upgrading for use as a liquid transportation fuel, such as a gasoline replacement.

PCT/EP20009/053550 discloses a process for the catalytic pyrolysis of solid biomass materials. The solid biomass material is pretreated with a first catalyst, and converted in a transported bed in the presence of a second catalyst. The product produces liquid reaction products having low oxygen content, as evidenced by low Total Acid Number (TAN) readings. The presence of two catalysts in the reactor increases the risk of over-cracking the biomass feedstock and/or the primary reaction products. The use of two catalysts in different stages of the process requires a complex catalyst recovery system.

Thus, there is a need for a catalyst system for use in a catalytic pyrolysis of solid biomass material capable of producing liquid reaction products having a high oil yield and having low oxygen content, while reducing the risk of over-cracking the biomass feedstock and/or the primary reaction products.

There is a particular need for a singular catalyst system.

There is a further need for such a catalyst system that can be made available at low cost.

### BRIEF SUMMARY OF THE INVENTION

The present invention addresses these problems by providing a catalytic system for use in catalytic pyrolysis of solid biomass material, said catalytic system comprising at least one metal oxide or metalloid oxide and having a specific combined meso and macro surface area in the range of from 1 m²/g to 100 m²/g.

Another aspect of the invention comprises a process for the catalytic conversion of a solid biomass material in which the catalyst system is used.

### DESCRIPTION OF ILLUSTRATIVE EMBODIMENTS

The following is a description of certain embodiments of the invention, given by way of example only.

The pyrolysis of biomass material can be carried out thermally, that is, in the absence of a catalyst. An example of a thermal pyrolysis process that may be almost as old as mankind is the conversion of wood to charcoal. It should be kept in mind that solid biomass materials in their native form invariably contain at least some amount of minerals, or “ash”. It is generally recognized that certain components of the ash may have catalytic activity during the “thermal” pyrolysis process. Nevertheless, a pyrolysis process is considered thermal if no catalysts are added.

The charcoal making process involves slow heating, and produces gaseous products and solid products, the latter being the charcoal. Pyrolysis processes can be modified so as to produce less char and coke, and more liquid products. In general, increasing the liquid yield of a biomass pyrolysis process requires a fast heating rate; a short reaction time; and a rapid quench of the liquid reaction products.

Fluidized bed reactors and transport reactors have been proposed for biomass pyrolysis processes, as these reactor types are known for the fast heating rates that they provide. In general, heat is provided by injecting a hot particulate heat transfer medium into the reactor.

U.S. Pat. No. 4,153,514 discloses a pyrolysis reactor in which char particles are used as the heat transfer medium.

U.S. Pat. No. 5,961,786 discloses a transport reactor type pyrolysis reactor, using sand as the heat transfer medium. Although the patent mentions the possibility of using mixtures of sand and catalyst particles or silica-alumina as the heat transfer medium, all examples in the patent are based on experiments in which sand was used as the sole heat transfer medium. According to data in the '786 patent, the use of sand produces better results than when char is used as the heat transfer medium.

The liquid product made by the process of the '786 patent is a liquid smoke flavoring product, intended to be used for imparting a smoke or BBQ flavor to food products, in particular meats. The liquid products are characterized by a low pH (around 3), and a high oxygen content. The patent specifically mentions the propensity of the liquid to develop a brown color, a property which is apparently desirable for smoke flavoring products. All three characteristics (low pH, high oxygen content, brown, and changing, color) are highly undesirable in liquid pyrolysis products intended to be used as, or upgraded to, liquid transportation fuels. Because of the low pH these liquid products cannot be processed in standard steel, or even stainless steel, equipment. Their corrosive character would require processing in glass or special alloys.

Due to the high oxygen content, upgrading of these liquids to produce an acceptable liquid transportation fuel, or an acceptable blending stock for a liquid transportation fuel, would require extensive hydrotreatment in expensive equipment, able to withstand the high pressures involved in such processes. The hydrotreatment would consume large amounts of expensive hydrogen.

PCT/EP 2009/053550 teaches a process for the catalytic pyrolysis of biomass material using a solid base as catalyst. The solid particulate biomass material was pre-treated with a different catalyst. The resulting liquid pyrolysis product had a low oxygen content, as evidenced by a low Total Acid Number (TAN). Best results were obtained with Na2CO₃ or K₂CO₃ as the pretreatment catalyst, and hydrotalcite (HTC) as the solid base catalyst.

Although the results reported in PCT/EP 2009/053550 have been confirmed in larger scale reactors, the use of two different catalysts, which are added at two different stages of the process, poses an inherent problem. Inevitably, the two catalyst materials become mixed with each other in the reactor. For a continuous process the two catalyst systems would have to be separated, so that one can be recycled to the pretreatment step, and the other to the pyrolysis reactor.

It has also been found that the proposed catalyst system tends to produce a coke yield that is higher than is necessary for providing the required heat to the process. Any coke beyond what is needed for the process is a loss of valuable carbon from the feedstock. It is important to minimize the coke yield as much as possible.

It is also desirable to identify catalytic materials carrying a lower cost than materials such as hydrotalcite.

The present invention addresses these issues by providing a catalytic system for use in catalytic pyrolysis of solid biomass material, said catalytic system comprising at least one oxide, silicate or carbonate of a metal or metalloid, and having a specific combined meso and macro surface area in the range of from 1 m²/g to 100 m²/g.

The catalytic system can be considered as having a catalytic activity for the pyrolysis of solid biomass material and/or for secondary reactions of pyrolysis reaction products. However, this catalytic activity is curtailed to avoid excessive formation of coke. Use of the catalytic system of this invention in a pyrolysis reaction permits the production of liquid pyrolysis products having an increased oil yield and a low oxygen content, similar or better than disclosed in PCT/EP 2009/053550. At the same time, the coke yield is significantly lower than that obtained with the catalytic systems disclosed in PCT/EP 2009/053550.

One aspect of the invention is the use of the oxides, carbonates and/or silicates of metals and metalloids, as distinguished from metals in their zero-valence or metallic form. The oxides, carbonates and silicates are far less catalytically active than metals in their zero-valence form. In a preferred embodiment the catalytic systems of the invention are substantially free of metals in their elemental or zero-valence form.

The term “metalloid” derives from the Greek “metallon” (=metal) and eidos (=sort), and refers to elements that, in the Periodic Table of Elements, are between the metals and the non-metals. The elements boron, silicon, germanium, arsenic, antimony, tellurium, and polonium, are generally considered metalloids. The elements to the left of the metalloids in the Periodic Table are considered metals, with the exception of course of hydrogen. Silicon is a highly preferred metalloid for use in the catalytic system of the invention, because of its abundant availability and low cost.

Of the metals, aluminum is highly preferred for use in the catalytic system of the invention. Other preferred metals include a metal selected from the group consisting of: 1) the alkaline earth metals selected from calcium, barium, and magnesium; 2) the transition metals selected from iron, manganese, copper and zinc; and 3) rare earth metals selected from cerium and lanthanum.

Another aspect of the invention is the use of such materials having a low to moderate specific surface area. The term “specific surface area” as used herein refers to the surface area of the meso and macro pores of a material determined by the BET method, and is expressed in m²/g. Meso porosity is at least about 2 nm up to about 10 nm, and macro porosity is at least about 10 nm. See the Article entitled “Surface Area and Porosity Determinations by Physisorption by James B. Condon, copyright 2006. In heterogeneous catalysis, catalytic activity takes place at the interface between the solid catalyst and the liquid or gas phase surrounding it. Formulators of solid catalysts generally strive to increase the specific surface area of catalyst particles in order to maximize the catalytic activity of the catalytic material. It is common to encounter solid catalyst materials having specific surface areas in excess of 150 m²/g or 200 m²/g. Even materials having a specific surface area in excess of 300 m²/g are not uncommon. In this respect the catalytic systems of the present invention depart from accepted wisdom in the field of catalysis in that the specific combined meso and macro surface area is not allowed to exceed 100 m²/g. Preferred are catalytic systems having a specific combined meso and macro surface area of 60 m²/g or less, more preferred are systems having a specific surface are of 40 m²/g or less.

The specific combined meso and macro surface area of the catalytic system should be high enough to provide meaningful catalytic activity, as inert materials are known to produce liquid pyrolysis products having a high oxygen content. In general, the catalytic system must have a specific combined meso and macro surface area of at least 1 m²/g, preferably at least 5 m²/g, more preferably at least 10 m²/g.

The term “catalytic system” as used herein refers to the totality of materials used in the pyrolysis reaction to provide catalytic and/or heat transfer functionality. Thus, the term encompasses a mixture of inert material and catalytic particles. In such a case, the specific surface area of the system is the specific surface area of a representative sample of the mixture of the two components.

The term “catalytic system” also encompasses mixtures of two or more different solid particulate catalytic materials. In such a case, the specific combined meso and macro surface area of the system is the specific combined meso and macro surface area of a representative sample of the mixture of particles.

The term “catalytic system” also encompasses composite particles comprising two or more materials. In such a case, the specific combined meso and macro surface area of the system is the specific combined meso and macro surface area of a representative sample of the composite particles.

The term “catalytic system” also encompasses a system consisting of particles of one catalytic material. In such a case, the specific combined meso and macro surface area of the system is the specific combined meso and macro surface area of a representative sample of the particles.

In general, catalytic systems are preferred in which each component, when used alone, has a specific combined meso and macro surface area in the range of from 1 to 100 m²/g, preferably from 2 to 60 m²/g, more preferably from 3 to 40 m²/g.

Minerals mined from the earth's crust may be suitable for use in the catalytic system of the invention. Examples include rutile, magnesia, sillimanite, andalusite, pumice, mullite, feldspar, fluorspar, bauxite, barites, chromite, zircon, magnesite, nepheline, syenite, olivine, wollasonite, manganese ore, ilmenite, pyrophylite, perlite, slate, anhydrite, and the like. Such minerals are rarely encountered in a pure form, and do generally not need to be purified for the purpose of being used in the catalyst system of the present invention. Many of these materials are available at low cost, some of them literally deserving the moniker “dirt cheap”.

Generally, minerals as-mined are not suitable for direct use in the catalytic system; such materials are referred to herein as “catalyst precursors”, meaning that they can be converted to materials for the catalyst system by some kind of pretreatment. Pretreatment may include drying, extraction, washing, calcining, or a combination thereof.

Calcining is a preferred mode of pretreatment in this context. It generally involves heating of the material, for a short period of time (flash calcination) or for several hours or even days. It may be carried out in air, or in a special atmosphere, such as steam, nitrogen, or a noble gas.

The purpose of calcining may be various. Calcining is often used to remove water of hydration from the material being calcined, which creates a pore structure. Preferably, such calcination is carried out at a temperature of at least 400° C. Mild calcination may result in a material that is rehydratable. It may be desirable to convert the material to a form that is non-rehydratable, which may require calcination at a temperature of at least 600° C.

Calcination at very high temperatures may result in chemical and/or morphological modification of the material being calcined. For example, carbonates may be converted to oxides. In general, catalyst manufacturers try to avoid such modifications, as they are associated with a loss of catalytic activity. For the purpose of the present invention, however, such phase modification may be desirable, as it can result in a material having a desired low catalytic activity.

Calcination processes aiming at chemical and/or morphological modification generally require high calcination temperatures, for example at least 800° C., or even at least 1000° C.

Examples of calcined materials suitable for use on the catalytic system of the invention include calcined coleminite, calcined fosterite, calcined dolomite, and calcined lime.

Calcination may also be used to passivate contaminants having an undesirably high catalytic activity. For example, bauxite, consisting predominantly of aluminum oxides, is an abundantly available material having a desirable catalytic activity profile. However, iron oxides, which are generally present in bauxite, may undesirably raise the catalytic activity of bauxite. Calcination at high temperature, for example at least 800° C. passivates the iron oxides so as to make the material suitable for use in the catalytic system, without requiring the iron oxides to be removed in an expensive separation step.

From this perspective, so-called “red mud” is an interesting material. It is a by-product of bauxite treatment in the so-called Bayer process, whereby the aluminum oxides are dissolved in caustic (NaOH) to form sodium aluminate. The insoluble iron oxides, which are brownish-red in color, are separated from the aluminate solution. This red mud is a troublesome waste stream in the aluminum smelting industry, requiring costly neutralization treatment (to get rid of the entrapped caustic) before it can be disposed of in landfill. As a result, red mud has a negative economic value. Upon calcination, however, red mud can be used in the catalytic system of the invention. Its alkaline properties are desirable, as it captures the more acidic (and more corrosive) components of the pyrolysis reaction product.

Steam deactivation can be seen as a special type of calcination. The presence of water molecules in the atmosphere during steam deactivation mobilizes the constituent atoms of the solid material being calcined, which aids its conversion to thermodynamically more stable forms. This conversion may comprise a collapse of the pore structure (resulting in a loss of specific surface area), a change in the surface composition of the solid material, or both. Steam deactivation is generally carried out at temperatures of at least 600° C., sometimes at temperatures that are much higher, such as 900 or 1000° C.

Phyllosilicate minerals, in particular clays, form a particularly attractive class of catalyst precursor materials. These materials have layered structures, with water molecules bound between the layers. They can readily be converted to catalyst systems of the invention, or components of such systems.

The general process will be illustrated with reference to kaolin clay. The process can be used for any phyllosilicate material, in particular other clays, such as bentonite or smectite clays. The term “kaolin clay” generally refers to clays, the predominant mineral constituent of which is kaolinite, halloysite, nacrite, dickite, anauxite, and mixtures thereof.

In the process, powdered hydrated clay is dispersed in water, preferably in the presence of a deflocculating agent. Examples of suitable deflocculating agents include sodium silicate and the sodium salts of condensed phosphates, such as tetrasodium pyrophosphate. The presence of a deflocculating agent permits the preparation of slurries having a higher clay content. For example, slurries that do not contain a deflocculating agent generally contain not more than 40 to 50 wt % clay solids. The deflocculating agent makes it possible to increase the solid level to 55 to 60 wt %.

The aqueous clay slurry is dried in a spray drier to form microspheres. For use in fluidized bed or transport reactors, microspheres having a diameter in the range of from 20 μm to 150 μm are preferred. The spray drier is preferably operated with drying conditions such that free moisture is removed from the slurry without removing water of hydration from the raw clay ingredient. For example, a co-current spray drier may be operated with an air inlet temperature of about 650° C. and a clay feed flow rate sufficient to produce an outlet temperature in the range of from 120 to 315° C. However, if desired the spray drying process may be operated under more stringent conditions so as to cause partial or complete dehydration of the raw clay material.

The spray dried particles may be fractionated to select the desired particle size range. Off-size particles may be recycled to the slurrying step of the process, if necessary after grinding. It will be appreciated that the clay is more readily recycled to the slurry if the raw clay is not significantly dehydrated during the drying step.

The microsphere particles are calcined at a temperature in the range of from 850 to 1200° C., for a time long enough for the clay to pass through its exotherm. Whether a kaolin clay has passed through its exotherm can be readily determined by differential thermal analysis (DTA), using the technique described in Ralph E. Grim's “Clay Minerology”, published by McGraw Hill (1952).

Calcination at lower temperatures converts hydrated kaolin to metakaolin, which generally has too high a catalytic activity for use in the catalytic system of the invention. However, calcination conditions resulting in a partial conversion to metakaolin, the remainder being calcined through the exotherm, may result in suitable materials for the catalytic system of this invention; which include but are not limited to fresh or used commercial catalysts comprising kaolin clay that have been exposed during commercial service to temperatures of at least 500° C. Typical examples of said used catalyst systems are FCC types, FCC/additives and mixtures thereof.

Materials as obtained by the above-described process are commercially available as reactants for the preparation of zeolite microspheres. For the purpose of the present invention, the materials are used as obtained from the calcination process, without further conversion to zeolite. The calcined clay microspheres typically have a specific surface area below about 15 m²/g.

If desired the slurry may be provided with a small amount of a combustible organic binder, such as PVA or PVP, to increase the green strength to the spray dried particles. The binder is burned off during the calcination step.

Processes similar to the one described herein for the conversion of kaolin clay can be used for producing microspheres from other catalyst precursors. Examples of suitable catalyst precursors include hydrotalcite and hydrotalcite-like materials; aluminosilicates, in particular zeolites such as zeolite Y and ZSM-5; alumina; silica; and mixed metal oxides. The process generally comprises the steps of (i) preparing an aqueous slurry of the precursor; (ii) spray drying the slurry to prepare microspheres; (iii) calcining the microspheres to produce the desired specific surface area. In this context it should be kept in mind that the term calcining as used herein encompasses steam deactivation. For highly active materials, such as zeolites, steam deactivation may be the preferred calcination process.

Another aspect of the present invention is the use of the catalytic system in a catalytic pyrolysis process of solid particulate biomass material.

The following example is provided to further illustrate this invention and is not to be considered as unduly limiting the scope of this invention.

### EXAMPLE

For the separate runs listed in the Table below, wood having a particle size ranging from about 10 micron to about 1000 micron was charged to a pyrolysis reactor for contact with several catalysts of differing chemical compositions and varying specific combined meso and macro surface areas (MSA), and at reactor temperatures ranging from about 850° F. to about 1100° F.

TABLE

| MSA, | Yields, wt % | | |
|---|---|---|---|
| m²/g | Bio-Oil | Gas | Char + Coke |
| 4 | 21.3 | 47.9 | 11.4 |
| 7 | 24.2 | 44.0 | 13.9 |
| 9 | 20.6 | 48.9 | 13.9 |
| 12 | 20.4 | 47.8 | 14.2 |
| 13 | 18.1 | 48.6 | 18.1 |
| 27 | 12.1 | 42.4 | 29.2 |
| 41 | 9.3 | 50.7 | 21.5 |
| 45 | 10.4 | 48.5 | 26.9 |
| 54 | 9.5 | 47.9 | 24.7 |
| 82 | 5.5 | 40.5 | 38.8 |
| 123 | 4.6 | 48.7 | 32.5 |

As can be seen from the Table above, irrespective of the chemical composition of the catalyst, the general trend of the Bio-oil yield decreases with increasing MSA to the point where the oil yield is not particularly commercially reasonable.
While the invention has been particularly shown and described with reference to specific embodiments, it should be understood by those skilled in the art that various changes in form and detail may be made without departing from the spirit and scope of the invention as defined by the appended claims.

What is claimed is:

1. A catalytic system for use in catalytic pyrolysis of solid biomass material, said catalytic system comprising at least one metal oxide or metalloid oxide and having a specific combined meso and macro surface area in the range of from 1 m²/g to 100 m²/g.

2. The catalytic system of claim 1 having a specific combined meso and macro surface area in the range of from 2 m²/g to 60 m²g.

3. The catalytic system of claim 1 having a specific combined meso and macro surface area in the range of from 3 to 40 m²g.

4. The catalytic system of claim 1 comprising at least one component obtained by calcining a catalyst precursor at a temperature of at least 600° C.

5. The catalytic system of claim 4 comprising at least one component obtained by calcining a catalyst precursor at a temperature of at least 800° C.

6. The catalytic system of claim 4 comprising at least one component obtained by calcining a catalyst precursor at a temperature of at least 900° C.

7. The catalytic system of claim 4 comprising at least one component obtained by calcining a catalyst precursor at a temperature of at least 1000° C.

8. The catalyst system of claim 4 wherein the catalyst precursor comprises a phyllosilicate mineral.

9. The catalyst system of claim 8 wherein the phyllosilicate mineral is a clay mineral.

10. The catalyst system of claim 9 wherein the clay mineral comprises kaolinite.

11. The catalyst system of claim 10 wherein the clay mineral comprises kaolin that has been exposed to temperatures of at least 500° C.

12. The catalyst system of claim 10 wherein the clay mineral comprises bentonite that has been exposed to temperatures of at least 500° C.

13. The catalyst system of claim 10 wherein the clay mineral comprises smectite.

14. The catalyst system of claim 4 wherein the catalyst precursor is hydrotalcite or a hydrotalcite-like material.

15. The catalyst system of claim 4 wherein the catalyst precursor is an aluminosilicate.

16. The catalyst system of claim 15 wherein the aluminosilicate is a zeolite Y, ion exchange Y zeolite, and/or is terminally treated, or dealuminated.

17. The catalyst system of claim 16 wherein the zeolite is zeolite ZSM-5.

18. The catalytic system of claim 1 comprising at least one component obtained by steam-deactivating a catalyst precursor at a temperature of at least 400° C.

19. The catalytic system of claim 18 comprising at least one component obtained by steam-deactivating a catalyst precursor at a temperature of at least 600° C.

20. The catalytic system of claim 18 comprising at least one component obtained by steam-deactivating a catalyst precursor at a temperature of at least 800° C.

21. The catalytic system of claim 1 wherein the catalytic system comprises a metal selected from the group consisting of: 1) the earth alkaline earth metals selected from, in particular calcium, barium, magnesium and iron; 2) the transition metals selected from iron, manganese, copper and zinc; and 3) rare earth metals selected from cerium and lanthanum.

22. The catalyst system of claim 1 comprising alumina.

23. The catalyst system of claim 22 wherein said alumina has been exposed to temperatures of at least 500° C.

24. The catalyst system of claim 1 comprising silica.

25. The catalyst system of claim 1 comprising a mixed metal oxide.

26. The catalyst system of claim 1 in the form of microspheres.

27. The catalyst system of claim 26 wherein the microspheres have a mean particle diameter in the range of from 20 to 200 μm.

28. The catalyst system of claim 26 wherein the microspheres have a mean particle diameter in the range of from 40 to 100 μm.

29. The catalyst system of claim 1 further comprising a binder.

30. A bio-oil produced from the catalytic pyrolysis of biomass in the presence of the catalyst system of claim 1.

31. The process of claim 30 wherein the yield of said bio-oil from said biomass is higher than the bio-oil yield resulting from use of catalyst systems having higher specific combined meso and macro surface area.

32. The process of claim 30 wherein the temperature of the catalytic pyrolysis reactor is at least 850° F.

33. A bio-oil produced from the catalytic pyrolysis of biomass in the presence of the catalyst system of claim 8.

34. A bio-oil produced from the catalytic pyrolysis of biomass in the presence of the catalyst system of claim 16.

35. A bio-oil produced from the catalytic pyrolysis of biomass in the presence of the catalyst system of claim 21.
